(19) United States
(12) Patent Application Publication
(10) Pub. No.: US 2025/0328115 A1
(43) Pub. Date: Oct. 23, 2025

(54) TECHNIQUES FOR VALIDATING OR VERIFYING CLOSED-LOOP TEST PLATFORMS

(71) Applicant: Robert Bosch GmbH, Stuttgart (DE)

(72) Inventors: Philipp Glaser, Stuttgart (DE); Joachim Sohns, Korntal-Muenchingen (DE); Patrick Weber, Rutesheim (DE)

(21) Appl. No.: 18/881,763

(22) PCT Filed: Jul. 12, 2023
(86) PCT No.: PCT/EP2023/069333

§ 371 Date: Jan. 7, 2025

(30) Foreign Application Priority Data
Jul. 25, 2022 (DE) 10 2022 207 563.3

(51) Int. Cl. G05B 13/04; G05B 13/02

(52) U.S. Cl. CPC G05B 13/041; G05B 13/0265

(57) ABSTRACT

A method for training a machine learning module to validate or verify a closed-loop test platform for testing a system. The method includes: providing data sets from multiple closed-loop test platforms of which at least one is a reference test platform, each data set containing input data and associated output data of a system under test in a respective closed-loop test platform; determining the similarity of portions of input data for pairs of the data sets, each pair of test data sets containing a data set of a reference test platform; determining similarities of portions of the output data associated with the portions of input data; and training a machine learning module to estimate the similarity.

### BACKGROUND INFORMATION

The use of virtual test platforms in the verification and validation of new systems (e.g. systems for autonomous or assisted driving) has tremendous potential and can contribute to shortening the validation process. In particular in the release of autonomous driving functions of level 3 and above (according to the SAE definition), the use of simulation-based test platforms is almost indispensable. The term “verification” refers to a comparison of the behavior and/or configuration of a system with a given specification. Verification is usually carried out using test cases that are derived from the requirements. Validation includes checking whether the system meets all of the required safety objectives and has all necessary quality characteristics. Validation goes beyond verification. Among other things, validation also includes checking the completeness of the requirements and the validity of the assumptions made. Used in the context of this disclosure, “testing” refers to checking quality requirements, safety objectives and other requirements for the system.

The use of virtual validation or verification can significantly reduce the scope of a test program in the field, for example, or even completely eliminate the need for such a test program (e.g. test drives with the system under test). Additionally or alternatively, the scope and/or quality of a test program can be increased without increasing the use of resources. This can contribute to reducing potential risks resulting from rare events, for instance. Testing the response of the system under test to rare events during test drives can be difficult. In order to observe a large number of specific rare events in the test drives, for instance, a prohibitive number of test kilometers may be needed. In a virtual validation or verification, rare events can easily be created by using a suitably selected scenario.

Virtual validation or verification presents new challenges, however. One fundamental challenge is the simulation of a surroundings of the system under test, or also the system under test itself in the virtual surroundings (e.g. a simulation of the input signals of a system for a system of a vehicle). Modeling the surroundings or selecting surroundings data always involves replacing an input signal of the real surroundings of the system with a simulated and/or synthesized input signal. The synthesized input signal can also have been generated on the basis of real data (e.g., error injection based on real error patterns). This raises the question whether relevant features or properties of the real surroundings are being changed or not represented. The absence of relevant features and the modification of said features can both lead to a system under test not being adequately tested during the virtual validation or verification. This can have a significant effect on the functionality and even the operational reliability of the system being tested in this way.

This is a risk in particular for closed-loop test platforms for virtual validation or verification. In a closed-loop test platform, a system under test is fed with input data (also referred to in this disclosure as “input signals”). Output data (also referred to in this disclosure as “output signals”) of the system under test are moreover fed back in order to feed the actions of the system under test back in the test environment. Based on this then, the input signals can be adjusted, etc. Thus, closed-loop test platforms can be used to test the behavior of a system under test when the system in turn affects its surroundings (and feedback loops are created). For closed-loop test platforms, the abovementioned problems are even more critical in some cases, because, in many situations, complex systems have to be mapped using different models; e.g. to create the input signals of a system under test (and process its output signals). As the complexity of closed-loop test platforms increases, the risk that a system under test will not be adequately tested during the virtual validation or verification generally increases as well (e.g. because certain events in the surroundings are not simulated, or are not simulated correctly). In a closed-loop test platform that simulates the surroundings of a system, for instance, the occurrence of expected reactions of the system in a certain situation does not always mean that a valid test of the system has been carried out with respect to the specific situation. It could therefore be the case that the simulation of the surroundings contains a different trigger for the expected reaction than the real surroundings.

Therefore, to reduce the risk of inadequate virtual validation or verification and the associated consequences (e.g. for the operational reliability of the system under test), measures for validating or verifying closed-loop test platforms are necessary. The techniques of this disclosure of the present invention address this task.

### SUMMARY

A first general aspect of present invention relates to a method for training a machine learning module to validate or verify a closed-loop test platform for validating or verifying a system. According to an example embodiment of the present invention, the method comprises providing a plurality of data sets from two or more closed-loop test platforms of which at least one is a reference test platform. Each data set contains input data and associated output data of a system under test in a respective closed-loop test platform. The method further comprises determining the similarity of portions of input data for pairs of the plurality of data sets. Each pair of data sets contains a data set of a reference test platform. The method also comprises determining the similarities of portions of the output data associated with the portions of input data and training a machine learning module to estimate the similarity of input data and output data of a data set of a closed-loop test platform to be validated or verified and the data sets of the plurality of data sets of the at least one reference test platform as a function of input data and/or output data of the data set of the closed-loop test platform to be validated or verified using the determined similarities to create a machine learning module for validating or verifying a closed-loop test platform.

A second general aspect of the present invention relates to methods for validating or verifying a closed-loop test platform for testing a system. According to an example embodiment of the present invention, the method comprises receiving a data set of a closed-loop test platform for testing a system and feeding at least a portion of the data set of the closed-loop test platform into a machine learning module for validating or verifying a closed-loop test platform. The machine learning module is trained to estimate the similarity of input data and output data of a data set of a closed-loop test platform to be validated or verified and data sets of at least one reference test platform as a function of input data and/or output data of the data set of the closed-loop test platform to be validated or verified. The method further comprises outputting one or more estimates of the similarity of input data and output data of a data set of a closed-loop test platform to be validated or verified.

A third general aspect of this disclosure relates to a computing unit configured to carry out the methods according to the first or second general aspects.

The techniques according to the first to third general aspects of this disclosure can in some cases have one or more of the following advantages.

Using the techniques of this disclosure can firstly make it possible to carry out validation or verification at the level of an (overall) system in some cases; even in situations in which the system under test and/or its surroundings is/are complex and have to be simulated using a plurality (possibly a large number) of (sub) models, for instance. In some approaches of the related art, the various (sub) models are validated or verified separately. This can be laborious. In some cases, the validation or verification can also only be carried out in an open loop, which, as described above, may not allow a reliable statement to be made about the behavior of the system in the field (i.e. in a closed-loop). The use of similarities between the input data and output data of the (overall) system to assess the validity of a closed-loop test platform, for example, makes it possible to identify whether specific behaviors of the system in specific operating scenarios are being adequately mapped and thus tested. The used data sets of the reference test platforms can represent adequate validations or verifications. An estimate of the machine learning module regarding the similarity of the input data and output data to the data sets of the reference test platforms can therefore in some cases enable a reliable statement as to whether a closed-loop test platform to be validated or verified adequately tests the behavior of a system. It is in particular possible to estimate whether the closed-loop test platform to be validated or verified tests relevant input data and whether this leads to expected output data of the system under test. In some techniques of the related art, it is only checked whether specific critical operating situations occur in the output data of the system under test, for example. It could, however, then be case that, for instance in a closed-loop test platform that simulates a surroundings of a system under test, completely different input data than in the field lead to the critical operating situations in the output data of the system under test. This, too, can mean that the closed-loop test platform does not adequately validate or verify certain behaviors of the system under test.

Secondly, the techniques of this disclosure can be used in some cases even if the data from different test platforms differ (e.g. not exactly the same operating scenarios were simulated/run or not all of the relevant conditions were recreated in the simulation). Data from an endurance test, for instance, can also be used (e.g. data recorded in systems in the field). This can reduce the effort required to validate or verify test platforms in some cases, because a wider range of data is available for validation or verification (e.g. previously collected data can continue to be used after changes in test protocols, or even data that was not collected during a test). In some situations, it is also possible to (more easily) compare test platforms from different manufacturers. The use of a machine learning module trained to estimate the similarity of input data and output data of a data set of a closed-loop test platform to be validated or verified and data sets of reference test platforms can enable reliable validation or verification even in the cases mentioned above.

Thirdly, the techniques of this disclosure can reduce the effort required to carry out the validation or verification (e.g. a simulation) in some cases. The input data and output data are compared portion by portion, in which case only a part of the input data and output data are considered depending on the operating scenario being investigated. In some cases, the portions can also be compactly represented using techniques to reduce their dimensionality. Both can make the training and also the application of the machine learning modules more efficient (e.g. in terms of memory space and/or computational effort).

The techniques of this disclosure can fourthly be used to identify operating scenarios or parameter ranges for which a closed-loop test platform has not yet been adequately validated or verified. If data appears in the data set of the closed-loop test platform to which no suitable datum of the reference test platform can be assigned, this is an indication that further data has to be collected for validation for the closed-loop test platform or submodels contained therein.

Some terms are used in this disclosure as follows:

A “closed-loop test platform” (loosely translated in German as a “test platform with feedback”) is any system that creates a test environment for a system under test, wherein the system under test is fed input data and output data from the system under test is also fed back into the test environment (and can influence it). In other words, the “closed-loop test platform” forms a feedback loop (and is therefore suitable for the validation or verification of systems or functions of systems in which feedback plays a role in the system behavior-which applies to a large number of systems). In a “closed-loop test platform”, a distinction is made between the system under test (in this disclosure, unless explicitly described otherwise, a part of the closed-loop test platform) and the surroundings of the system under test. In some cases, a closed-loop test platform can simulate both the system to be validated or verified and its surroundings. In other examples, a real system to be validated or verified can be inserted into the closed-loop test platform (the term “real” is used here in contrast to the term “simulated”—the real system is used later in this form as well; a simulated system mimics a real system; real surroundings are the surroundings in the field or in the application). The system under test can be in any possible form. The system under test can be a hardware system, a software system or a system comprising hardware and software components, for instance. In this disclosure, a system under test in the field or on a test stand is also a closed-loop test platform (e.g. a test vehicle that contains a system under test—the test environment here can be a real surroundings of the system under test in use).

“Input data” refers to all data transmitted to the system under test in a closed-loop test platform (e.g. to simulate a surroundings of the system under test or from a real surroundings of the system under test). The input data can include data simulated or synthesized using models or otherwise, and/or real data (which can be recorded/generated in real-time or retrieved from a database and/or can be modified by means of one or more processing steps). The input data can, for instance, include real data that is manipulated in some way. In some cases, the input data can include time records. However, the input signals can also have any other possible format.

“Output data” refers to all data output in the closed-loop test platform from the system under test, or acquired or derived with respect to the system under test (e.g. by an agent that monitors a behavior of the system under test). The output data can be at least partially fed back into the surroundings of the closed-loop test platform and/or made available for monitoring purposes.

The terms “surroundings” or “test environment” refer to the context into which a system under test is embedded (i.e. in the intended application). The surroundings can generate the input data of the system under test. The output data of the system under test can also (at least in part) in turn affect the surroundings. The surroundings can include other systems (e.g. other systems which the system under test is connected when it is being used) and/or objects of the surroundings in which the system under test operates in the intended application. The surroundings (or system under test) defines one or more interfaces via which data are transmitted from the surroundings to the system (or vice versa). In some closed-loop test platform, the surroundings are simulated. The surroundings can therefore be simulated in such a way that the data passed to the system in use are simulated in such a way that a functionality of the system can be tested.

A “system” can be any device or group of devices designed for a specific purpose, e.g. one or more regulation, control, communication and/or monitoring tasks. A system can be a component of a higher-level (further) system. A system can be software. In other examples, a system can be a hardware component (in some examples with associated software). A system can be an embedded system, for instance. In some examples, the system can be a vehicle or a module for a vehicle (e.g. for a motor vehicle). In other examples, the system can be a robot or a module for a robot. In yet other examples, the system can be an industrial facility or machine or a module for an industrial facility or machine. In yet other examples, the system can be a tool or a module for a tool.

According to this disclosure, a “machine learning module” is any hardware and/or software module that is or can be trained for a task by means of machine learning. For this purpose, the machine learning module has parameters that are changed during training with a training data set in such a way that desired output data are generated in response to specific input data. Ideally, the thus trained machine learning module also processes unknown input data (i.e. data that is not included in the training data set) in a desired manner. A machine learning module can comprise one or more artificial neural networks, but is not limited to this topology. A machine learning module can be implemented in any suitable manner. A machine learning module can, for instance, be a software module (i.e. the functionality is defined in software that can be executed on a non-specific computing unit). In other examples, the machine learning module can be a hardware module (i.e. the functionality of the machine learning module is defined in hardware). In still other examples, the functionality of the machine learning module can be defined in software and in hardware.

A “vehicle” in this disclosure is any device for transporting passengers (including drivers) and/or goods. A vehicle can be at least partially autonomous or assisted. A vehicle can be a motor vehicle, but also any other land vehicle. Floating, submersible and/or flying devices can also be vehicles according to this disclosure.

### BRIEF DESCRIPTION OF THE DRAWINGS

FIG. 1 shows a flow chart of a method for training a machine learning module to validate or verify a closed-loop test platform for testing a system according to an example embodiment of the present invention.

FIG. 2 schematically illustrates the methods for training according to an example embodiment of the present invention.

FIG. 3 schematically illustrates an example of a method for training a machine learning module according to the present invention.

FIG. 4 schematically shows a closed-loop test platform, according to an example embodiment of the present invention.

FIG. 5 shows a flow chart of a method for validating or verifying a closed-loop test platform for testing a system according to an example embodiment of the present invention.

FIG. 6 schematically illustrates an example of a method for validating or verifying a closed-loop test platform according to the present invention.

FIG. 7 shows an example output of a method for validating or verifying a closed-loop test platform according to the present invention.

FIG. 8 shows another example output of a method for validating or verifying a closed-loop test platform according to the present invention.

### DETAILED DESCRIPTION OF EXAMPLE EMBODIMENTS

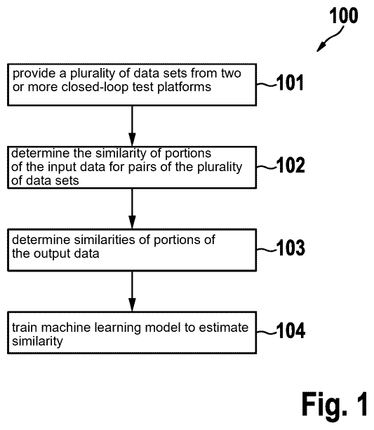

First, the techniques for training a machine learning module to validate or verify a closed-loop test platform for testing a system according to this disclosure are explained with reference to FIG. 1 to FIG. 4. The techniques for validating or verifying a closed-loop test platform for testing a system according to this disclosure (i.e., the application of the trained machine learning module) are then discussed with reference to FIG. 5 to FIG. 8.

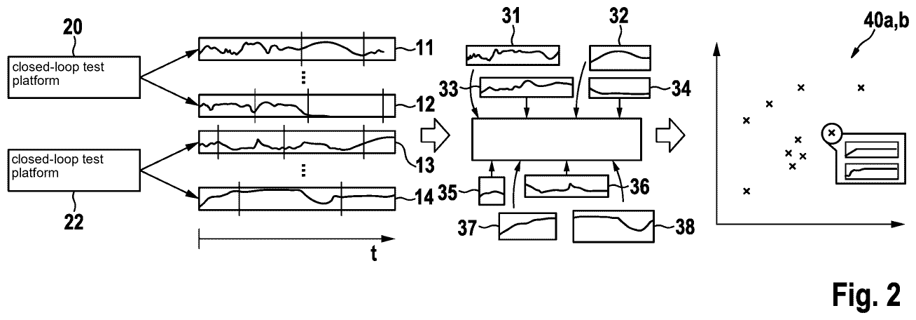

FIG. 1 shows a flow chart of a method 100 for training a machine learning module to validate or verify a closed-loop test platform for testing a system according to this disclosure. FIG. 2 schematically illustrates the methods for training of this disclosure.

The method for training a machine learning module to validate or verify a closed-loop test platform for validating or verifying a system includes providing 101 a plurality of data sets 11-14 from two or more closed-loop test platforms 20, 22. The closed-loop test platforms include at least one reference test platform 22 (in this disclosure, the term “reference test platform” is used as an abbreviation for the term “reference closed-loop test platform”). The reference test platform 22 or its data sets 13, 14 are used as reference points for estimating the similarities during training. In other words, the machine learning module is trained to estimate how similar the input and output data of the closed-loop test platforms to be validated or verified are to the input and output data of the reference test platform(s) 22. In some examples, reference test platform(s) can be closed-loop test platforms that have already been validated or verified or are otherwise trusted to have adequately tested the system under test.

Each data set 11-14 contains input data and associated output data of a system under test in a respective closed-loop test platform 20, 22 (not broken down in FIG. 1 and FIG. 2). Providing can include any operation with which the plurality of data sets 11-14 are made accessible for subsequent processing.

A data set 11-14 can include any data produced during operation of the closed-loop test platform with the system under test. A data set 11-14 can include data produced in a specific time interval during operation of the closed-loop test platform with the system under test, for instance. As mentioned above, a system in the field is also a closed-loop test platform according to this disclosure. A data set 11-14 can therefore also include data produced during operation of the system in the application and/or the field (even if the system can then not be tested in a strict sense).

A data set 11-14 can include data for one or more test runs of a closed-loop test platform with the system under test. In some examples, a test run can involve a specific operating scenario of the system under test and/or a specific operating situation (e.g. an operating state) of the system under test (e.g. the test run can simulate the operating scenario or the operating situation). In this case, the input data and output data can be data produced during the specific operating scenario and/or the specific operating situation of the test run in question (more on this below). In other examples, however, a data set can also be included without simulating a specific operating scenario of the system under test and/or a specific operating situation of the system under test. The data set 11-14 can include data produced in an endurance test of the closed-loop test platform with the system under test, for example.

In this disclosure, an operating scenario or an operating situation can be any constellation that occurs during operation of the system under test or any state that occurs during operation of the system under test (e.g. characterized by specific values of operating parameters of the system under test or parameters of its surroundings). An operating scenario or an operating situation can involve specific ambient conditions or surroundings configurations of the system, for instance (e.g. driving in specific ambient conditions, or surroundings configurations). Additionally or alternatively, an operating scenario or an operating situation can include a violation of safety objectives. Further additionally or alternatively, an operating scenario or an operating situation can involve a critical state of the system under test or an error state of the system under test.

The input data can include all data that is fed to the system under test during operation of the respective closed-loop test platform. The input data can be structured and/or formatted differently depending on the closed-loop test platform and/or the system under test and/or the type of operation (e.g. a specific test run or an endurance test). In some examples, the input data include those signals that the system under test obtains from the surroundings (e.g. sensor signals or output signals of other systems upstream of the system under test and/or in communication with the system under test) during operation (e.g. during a specific test run or an endurance test). These signals are also referred to in this disclosure as input signals. In some examples, the input data can at least partially include one or more time records (as shown in FIG. 2). The time records can map one or more parameters or variables over time (i.e. be one-dimensional or multidimensional). Time records can also map the temporal progression of complex data structures (e.g. object lists or images).

The output data can include all data output from the system under test during operation of the respective closed-loop test platform (e.g. during a specific test run or an endurance test). In some examples, this output data can include data that is fed back into the closed-loop test platform (e.g. during a test run or an endurance test). Additionally or alternatively, the output data can include data included for the purpose of monitoring the system under test (e.g. data that characterize a behavior of the system under test). In this disclosure, the output data are also referred to as output signals. Like the input data, the output data can be structured and/or formatted differently depending on the closed-loop test platform and/or the system under test and/or the type of operation (e.g. a specific test run or an endurance test). In some examples, the output data can at least partially include one or more time records. The time records can map one or more parameters or variables over time (i.e. be one-dimensional or multidimensional).

Output data can be associated with the input data if produced in the same operation (e.g. during a specific test run or an endurance test) in temporal relation to the input data (e.g. substantially simultaneously or with an upwardly limited time offset). In other words, the associated output data are the data that the system outputs, or that are recorded when monitoring the system as it processes specific input data (e.g. during a test run or an endurance test).

In some examples, both the input data and the output data are processed (e.g. filtered or further processed into another format). It is therefore not necessary (but possible) that the input and/or output data are processed in the form in which they are produced in the closed-loop test platform. In other examples, the input and/or output data are derived from the data in which they are produced in the closed-loop test platform. In some examples, the input data and/or output data include all data produced in the closed-loop test platform (e.g. during a test run or an endurance test). In other examples, the input data and/or the output data are only a selection of the data produced in the closed-loop test platform (e.g. during a test run or an endurance test).

In some examples, the method can also include generating one or more of the plurality of data sets 11-14 (e.g. by carrying out a corresponding test run using the closed-loop test platform 20, 22). Alternatively or additionally, one or more of the plurality of data sets 11-14 can already be available.

The method further comprises determining 102 the similarity of portions 31-38 of the input data for pairs of the plurality of data sets 11-14. Each pair of test data sets includes a data set 13, 14 of a reference test platform 22 (and therefore a second data set 11, 12 of a further closed-loop test platform 20). Aspects of the manner of ascertaining the similarities (e.g. applicable similarity metrics) are described further below. In other words, for a first portion 31 of a first data set 11, for example, a similarity to a second portion 35 of a second data set 13 (a reference test platform 22) is determined. This procedure can then be repeated for further (first) and further (second) portions (e.g. more than 100, more than 1000, or more than 100,000 portions). Additionally or alternatively, portions of different pairs of data sets can be compared.

A portion is a part of the input data and/or a part of a data element of the input data (i.e. less than the complete input data and/or less than a complete data element of the input data). If a data element of the input data (or the entire input data) is a time record, a portion can then be a time record of a shorter duration than the entire time record (i.e. a time portion of the time record). In some examples, a length of one of the time portions can be set within a predetermined (fixed or variable) duration (which can depend on the type of system under test and/or the operation). The predetermined duration can be shorter than 2 minutes (e.g. shorter than 30 seconds or shorter than 15 seconds). Additionally or alternatively, the predetermined duration can be longer than 2 seconds (e.g. longer than 5 seconds). These durations can in particular be relevant for systems used in vehicles.

In other examples, a portion according to a criterion other than time can characterize a part of the input data and/or a part of a datum of the input data (e.g. a section of an image of a series of image data or a section of an object list).

In some examples, the method includes decomposing the input data or a datum of the input data into multiple portions 31-38 (as shown in FIG. 2 using the time records). The portions can be disjunct (i.e. have no common data points) or overlap. The above-described ascertainment of the similar portions can be carried out for each of the portions.

In some examples, the method can include ascertaining similar portions 31-38 of input data for pairs of the plurality of data sets 11-14 (wherein each pair of test data sets includes a data set 13, 14 of a reference test platform 22). In some examples, the similarities are determined only for the ascertained similar portions. In other words, for a first portion 35 of a first data set (e.g. a test data set 13, 14 of a reference test platform 22), for example, a similar second portion 31 of a second data set 11, 12 is ascertained (and a similarity is determined as necessary). This procedure can then be repeated for further (first) and further (second) portions. If the plurality of data sets includes more than two data sets, ascertaining similar portions (and determining similarities as necessary) can be carried out for multiple (e.g. all) pairs of the plurality of data sets. Several similar (second) portions can also be ascertained for one specific (first) portion (and the corresponding similarities determined). Of course, it is also possible that no similar other portion can be found for a specific portion.

In some examples, the techniques of this disclosure can also include finding pairs of portions of input data for training a machine learning module to validate or verify a closed-loop test platform (i.e. the pairs used to determine 102 similarities of the input data). In other words, the plurality of data sets can first be searched for portions of input data that are paired with one another and the similarity of which is determined later as described. Finding can include the above decomposition of the input data and/or the ascertainment of similar portions.

Finding pairs of portions of input data can include comparing multiple different possible combinations of data pairs (i.e. two data sets) from the plurality of data sets and selecting one or more of the different combinations of data pairs according to a predetermined criterion. The possible combinations can be created by varying different parameters. A length of the portions can be selected differently, for instance. Additionally or alternatively, the portions of a pair can be offset differently to one another in terms of time. In one example, the portions of the data sets of a pair can be convolved (optionally additionally using a variable length of the portions). Similarity can be determined for each of the possible combinations in any case (e.g. using the techniques described in this disclosure) and combinations with the greatest similarity and/or similarity greater than a specific measure can be selected.

In some examples, the portions of input data can additionally or alternatively be decomposed into smaller and smaller units (e.g. time periods) to select the pairs. First, for a first variable (e.g. a first operating parameter), a portion of the input data can be identified in which a specific criterion is satisfied (for example approximate stationarity or a similar criterion). A second variable (e.g. a second operating parameter) is considered for the respective portion and the portion is decomposed into smaller parts, in each of which a specific criterion for the second variable is again satisfied. In some examples, this procedure can be repeated for one or more further variables. This results in a plurality of shorter portions (than the original portion), in which respective specific criteria are satisfied for all of the treated variables (first variable, second variable, etc.). These portions can be ascertained both in the input data of the data sets of the at least one reference test platform and in the further data sets and compiled into the pairs, the similarities of which are determined as described in this disclosure.

The method also includes determining 103 the similarities 50 of portions of output data associated with the portions of input data 31-38 (i.e. the portions for which similarities are determined and/or have been ascertained) (not shown in FIG. 2). A similarity of the associated portions of output data is thus determined for each pair of portions of input data 31-38. Again, the similarity metrics that can be used are described below (different similarity metrics can be used for the comparison of the portions of input data and the comparison of the portions of output data). The portions of output data can be configured like the portions of input data. If a datum of the output data (or the entire output data) is a time record, for example, a portion can then be a time record of a shorter duration than the entire time record (i.e. a time portion of the time record). In some examples, a length of one of the time portions can be set within a predetermined (fixed or variable) duration (which can depend on the type of system under test and/or the test run). The predetermined duration can be shorter than 2 minutes (e.g. shorter than 30 seconds or shorter than 15 seconds), as for the portions of input data. Additionally or alternatively, the predetermined duration can be longer than 2 seconds (e.g. longer than 5 seconds). In some examples, the durations of the portions of output data can be different from the durations of the portions of input data.

In some examples, portions of output data and/or input data are selected to include data relating to one or more predetermined operating situations and/or operating scenarios of the system in the respective closed-loop test platform.

The one or more predetermined operating situations and/or operating scenarios can, for instance, be critical operating situations and/or operating scenarios of the system (e.g. critical for the functionality or operational reliability of the system). The criticality can be determined using a predetermined criticality criterion. The predetermined criticality criterion can be configured differently depending on the type of system under test. In some examples, a criticality criterion can be an operating situation of the system or a state of its surroundings having one or more predetermined characteristics (e.g. a specific error has occurred, a specific event (e.g. a specific anomaly) has occurred in the system or its surroundings, the input signals and/or the output signals of the system satisfy one or more predetermined conditions).

In the case of a system for a vehicle, for example, critical operating situations and/or operating scenarios of the system can be critical driving situations and/or driving scenarios. These can include one or more of driving under particular ambient conditions (e.g. light conditions or weather conditions), critical objects or occurrences in the surroundings of the system (missing or incorrect lane markings, obscured objects, sharp turns) or specific driving maneuvers (e.g. driving above a specific speed). In some examples, critical driving situations and/or driving scenarios can include one or more critical driving situations and/or driving scenarios which are described in the ISO/PAS 21448:2019 standard (English title “Road vehicles-Safety of the intended functionality”) as “triggering events”.

The method also comprises training 104 a machine learning module to estimate the similarity of input data and output data of a data set of a closed-loop test platform to be validated or verified and the data sets 13, 14 of the plurality of data sets of the at least one reference test platform 22 as a function of input data and/or output data of the data set of the closed-loop test platform to be validated or verified using the determined similarities 50 to create a machine learning module for validating or verifying a closed-loop test platform. In other words, the objective of the training is for the machine learning module to estimate how similar a test data set (and thus the closed-loop test platform generating said data set) is to the one or more data sets 13, 14 of the at least one reference test platform 22 used for the training.

This estimation result can be used to validate or verify the closed-loop test platform (and/or the system included contained therein). If the data sets 13, 14 of the at least one reference test platform 22 adequately validate or verify the operating behavior of the system under test, for instance, it is possible to estimate whether a closed-loop test platform to be validated or verified exhibits similar behavior with respect to the input data and output data, as the data sets 13, 14. If this is the case, it can be assumed that the closed-loop test platform to be validated or verified also adequately validates or verifies the operating behavior of the system under test.

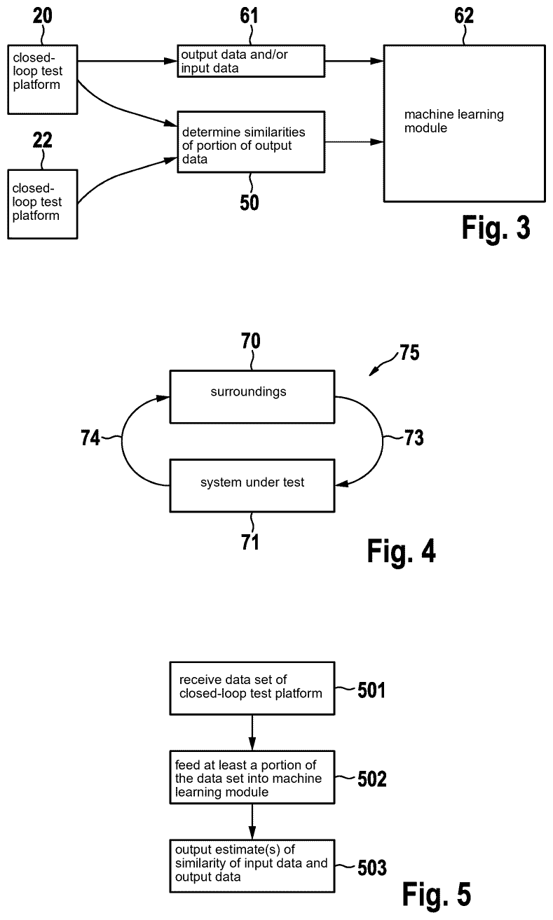

Further aspects of training the machine learning module will now be discussed with reference to FIG. 3. FIG. 3 schematically illustrates an example of a method for training a machine learning module 62 of this disclosure.

The machine learning module 62 can receive at least a part of the output data and/or the input data 61 for the data sets that are not generated with the at least one reference platform (in FIG. 3, the (first) closed-loop test platform 20) as an input variable, and generate the estimate of the similarity of the input data and the output data as an output variable. During training, the specific similarities 50 are used as ground truth (i.e. the expected output variable of the machine learning module). A similarity ascertained by means of a specific similarity metric can be used directly or processed. A similarity can be normalized and/or scaled, for example. In other examples, a similarity can be divided into two or more classes (e.g. binarily into the classes “similar” or “dissimilar”). The machine learning module 62 can therefore be trained to estimate the similarities 50 of the input data and the output data based on the at least one part of the output data and/or the input data 61. The training can be implemented using any suitable training method for machine learning modules. A loss function (i.e. a difference between the real similarities and the output of the machine learning module 62), for instance, can be gradually reduced by adjusting the parameters of the machine learning module (e.g. by using a backpropagation algorithm and/or a gradient descent algorithm).

In some examples, the machine learning module 62 receives only a part of the output data and/or input data as input variables. In that case then, the machine learning module 62 can be trained (and ultimately be trained) to estimate the similarity of input data and output data based on a smaller and/or different part of the output data and/or input data of a data set of a system under test than was used to determine the similarities during training of the machine learning module 62 (e.g. a wider selection of input data and output data is used to determine the similarities during training of the machine learning module 62). The machine learning module 62 can, for instance, be trained (and then as a result be trained) to estimate similarities between input data and output data based on only a part of the output data of a system under test in a closed-loop test platform. In other examples, the machine learning module 62 can be trained (and then as a result be trained) to estimate similarities between input data and output data based on only a part of the input data of a system under test in a closed-loop test platform.

In some examples, the part of the input data and/or output data 61 can additionally or alternatively contain information that characterizes an operating scenario acquired or simulated with the respective closed-loop test platform 20, 22 or an operating situation acquired or simulated with the respective closed-loop test platform 20, 22 of a system included in the closed-loop test platform. A portion of input data can characterize an operating scenario or an operating situation (e.g. a time record during the operating scenario or the operating situation), for instance. This portion can be an input variable of the machine learning module 62 in use (for which the machine learning module 62 estimates the similarities 50). Additionally or alternatively, a portion of output data can characterize an operating scenario or an operating situation (e.g. a time record during the operating scenario or the operating situation). This portion can likewise be an input variable of the machine learning module 62 in use (for which the machine learning module 62 estimates the similarities).

The machine learning module 62 can have any structure suitable to being trained to estimate the similarities of the input data and output data. In some cases, the machine learning module 62 can comprise an artificial neural network (e.g. a deep neural network and/or a convolutional neural network).

The machine learning module 62 can be configured to estimate a first similarity for the input data and a second similarity for the output data (e.g. a similarity of the input data and associated output data of the closed-loop test platform to be validated or verified and the corresponding data of the at least one reference test platform). The similarities can be classified by the machine learning module 62 (i.e. the machine learning module 62 outputs the similarity for a data set of a closed-loop test platform to be validated or verified in two or more classes, e.g. binarily in the classes “similar” or “dissimilar”). The machine learning module can also output a probabilistic classification into multiple classes of similarity. The machine learning module 62 in these examples is a classifier. In other examples, the machine learning module 62 can output a metric or other characteristic variable for the similarity (e.g. from 0% to 100%). The machine learning module 62 in these examples is a regressor. In any case, the output of the machine learning module 62 can be used to identify whether a data set for a closed-loop test platform adequately tests a system under test (i.e. in a manner similar to the at least one reference test platform).

As described above, similarities are determined for both the portions of input data and the portions of output data. These ascertainments can be implemented in some examples in one of the following ways.

In some examples, determining the similarities of the portions of input data can comprise determining a distance between a first portion of input data of a first data set of the respective pair and the input data of a second portion of the second data set of the pair. In other words, a distance between the first portion of input data of a first data set of the respective pair and the second portion of input data of the second data set of the pair is calculated using a suitable distance metric. A greater distance means a lower similarity (and vice versa). The distance metric can be selected based on the type of input data being compared. Example distance metrics include a Euclidean distance, a Manhattan distance, or a distance of a higher vector norm (for one-dimensional or multidimensional portions of input data that span a Euclidean space). Other examples of distance metrics include a Hamming distance or a Levenshtein distance (e.g. for character strings). In other examples, the distance metric can include a distance metric for distributions (e.g. distance metrics for probability distributions, e.g. an earth mover's distance, EMD, or a Wasserstein distance—e.g. for point clouds detected by a radar or LiDAR).

In some examples, the portions of input data can be directly compared to the appropriate distance measure. In other examples, the portions can undergo one or more preprocessing stages. For instance, determining the similarities can include compressing the individual portions and comparing the compressed portions of input data. In some examples, compressing the individual portions can include generating a datum characteristic of the respective portion with lower dimensionality than the original portion. Compressing the individual portions can additionally or alternatively include carrying out one or more dimensionality reduction techniques on the individual portions (e.g. selecting the one or more most important principal components in a principal component analysis, omitting least significant bits, etc.). In some examples, a portion of a scalar or vector time record can be represented by a single scalar or vector datum (i.e. the time dimension is eliminated). A vector datum can additionally or alternatively be represented by a lower dimension vector datum or a scalar datum (in this disclosure, a vector has at least two entries). Compression and/or dimensionality reduction can be helpful because input data in particular can be high dimensional in many closed-loop test platforms.

The portions of input data can additionally or alternatively be normalized or otherwise standardized. This makes it possible to compare portions of input data having different formats (e.g. length or dimensionality) and/or different ranges of values. The compression and/or dimensionality reduction techniques described above can also be used in some examples to standardize the portions of input data. Sections (of different length or dimension) can each be represented by a scalar, for example. These techniques can improve the comparability of portions of input data of various closed-loop test platforms.

In the preceding sections, processing aspects (in particular relating to the determination of similarities) were described primarily for the portions of input data. However, the techniques can also or alternatively be applied to the portions of output data. For instance, determining the similarities of the portions of output data can comprise determining a distance between a first portion of output data of a first data set of the respective pair and a second portion of the second data set of the pair. In other words, a distance between the first portion of output data of a first data set of the respective pair and the second portion of input data of the second data set of the pair is calculated using a suitable distance metric. A greater distance means a lower similarity (and vice versa). The other techniques described above can likewise be used for the output data.

The closed-loop test platforms, the data of which are used to train the machine learning module 62, can take various forms. FIG. 4 schematically shows a closed-loop test platform 75.

As described above, the closed-loop test platform 75 can include a system 71 under test and a surroundings 70 of the system under test. The surroundings 70 supplies input data 73 to the system 71 under test. The input data 73 can be simulatively generated or otherwise synthesized (e.g. the surroundings 70 are recreated in a simulation). In other examples, the input data 73 can be real data from the surroundings of the system 71 under test (e.g. in a test stand or during operation of the system 71 under test in the field—in these examples, the surroundings 70 can at least partially comprise the real surroundings of the system or a hardware simulation thereof). In still other examples, input data 73 can include real data that is modified by one or more processing steps (e.g. error injection based on real error patterns). Output data 74 of the system 71 under test can then be fed back into the surroundings 70 (and generate new input data 73 there), etc.

In some examples, a closed-loop test platform 75 can be a software-in-the-loop test platform. In this case, the system 71 under test is software (i.e. the system is formed by software). In use, the software can be part of a higher-level system (e.g. a component that contains the software and in which the software carries out a predetermined function). In a software-in-the-loop test platform, the input data 73 and the output data 74 are supplied or tapped via a software interface. The software is executed during a test run or in an endurance test (on a suitable computing unit) in order to simulate operation in use. The surroundings 71 can be recreated simulatively and/or using real systems.

In some examples, a closed-loop test platform 75 can be a model-in-the-loop test platform. In this case, the system 71 under test is a model of another system (e.g. a model of a system that will ultimately be used in an application). In these examples, the technical system can again be software (i.e. software that models the other system). In these model-in-the-loop test platforms, the input data 73 and the output data 74 are supplied or tapped via a software interface (wherein the input data are adapted to the respective model). The model is executed during a test run or in an endurance test (on a suitable computing unit) in order to simulate operation in use. The surroundings 71 can be recreated simulatively and/or using real systems.

In still other examples, a closed-loop test platform 75 can be a hardware-in-the-loop platform. In this case, the system 71 under test is a hardware component (which can itself also include software). The system under test can be a hardware component intended for an application, for instance. In a hardware-in-the-loop test platform, the input data 73 and the output data 74 can be supplied/queried via existing interfaces of the hardware component. The surroundings 71 can be recreated simulatively and/or using real systems.

In yet other examples, a closed-loop test platform 75 can include the system 71 under test in the field or on a test stand. In that case, the system 71 under test can be a hardware component (which can itself also include software) or a software component. The system under test can be a hardware component or software component intended for an application, for instance. Again, the input data 73 and the output data 74 can supplied/queried via existing interfaces of the hardware component or software interfaces. In these examples, the surroundings 71 is a real surroundings of the system in the field or on a test stand.

As described above, the machine learning module 62 is trained using a plurality of data sets that are generated with different closed-loop test platforms 75. The above-described closed-loop test platforms can be combined in any way. It is in particular possible for each type of closed-loop test platform 75 described above to be a reference test platform.

In some examples, the at least one reference test platform can include a closed-loop test platform 75 of a first type and the other closed-loop test platform(s) can include a closed-loop test platform 75 of a second type.

The at least one reference test platform can additionally or alternatively include a closed-loop test platform 75 that comprises the system 71 under test in the field or on a test stand. In other words, the reference test platform can include the real system under test. This can ensure the quality of the data sets of the reference test platform (because problems, for example, can be reduced by simulating the system and/or its surroundings). Alternatively or additionally, the at least one reference test platform can also include another of the abovementioned closed-loop test platforms 75 (e.g. a closed-loop test platform in which the surroundings and/or the system under test are simulated with greater effort than in other closed-loop test platforms to be validated or verified and/or a closed-loop test platform the behavior of which has already been validated or verified).

As explained above, the techniques of this disclosure can be used for any systems that are tested in closed-loop test platforms. In some examples, the system under test is a vehicle or a module for a vehicle (e.g. for a motor vehicle). The system can be configured to be installed in the vehicle itself and/or to communicate with the vehicle (e.g. in a backend or infrastructure component that provides a functionality for the vehicle. In some examples, the system can provide a functionality for assisted or autonomous driving of a vehicle.

Essential aspects of training a machine learning module to validate or verify a closed-loop test platform for testing a system have been described in connection with FIG. 1 to FIG. 4. In the following sections, applications of a trained machine learning module for validating or verifying a closed-loop test platform for testing a system are discussed in more detail.

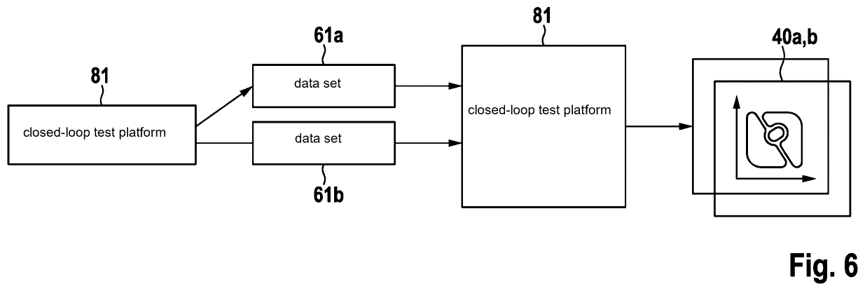

FIG. 5 shows a flow chart of a method for validating or verifying a closed-loop test platform for testing a system according to this disclosure. FIG. 6 schematically illustrates an example of a method for validating or verifying a closed-loop test platform 81 of this disclosure.

The method comprises receiving 501 a data set 61a, 61b of a closed-loop test platform 81 for testing a system. The objective of the method is to validate or verify the data set 61a, 61b or the closed-loop test platform 81 with which the data set 61a, 61b was generated. The data set 61a, 61b can be structured in the same way as the data sets described above with respect to training the machine learning module (e.g. the data set contains input data and associated output data, as discussed above). In some examples, the data set can include only input data or only output data (e.g. only selected input data or output data).

As explained above, the techniques of this disclosure can be used for any systems that are tested in closed-loop test platforms. In some examples, the system under test is a vehicle or a module for a vehicle (e.g. for a motor vehicle). The system can be configured to be installed in the vehicle itself and/or to communicate with the vehicle (e.g. in a backend or infrastructure component that provides a functionality for the vehicle. In some examples, the system can provide a functionality for assisted or autonomous driving of a vehicle.

The method further comprises feeding 502 at least a portion of the data set 61a, 61b of the closed-loop test platform 81 into a machine learning module 83 for validating or verifying a closed-loop test platform. The part of the test data set 61a, 61b can, for instance, include input data and/or output data that contains information that characterizes an operating scenario acquired or simulated with the closed-loop test platform 81 of a system included in the closed-loop test platform 81 or an operating situation acquired or simulated with the closed-loop test platform 81 of a system included in the closed-loop test platform 81. The part of the input data can characterize an operating scenario or an operating situation (e.g. a time record during the operating scenario or the operating situation), for instance.

The machine learning module 83 is trained to estimate the similarity of input data and output data of a data set of a closed-loop test platform to be validated or verified and data sets of at least one reference test platform as a function of input data and/or output data of the data set of the closed-loop test platform to be validated or verified using the determined similarities.

The method also comprises outputting 503 one or more estimates 40a, 40b of the similarity of input data and output data of a data set 61a, 61b of the closed-loop test platform for testing a system 81 (i.e. the closed-loop test platform to be validated or verified) and the data sets of the at least one reference test platform with the machine learning module 83. In some examples, a first similarity for the input data and a second similarity for the output data can be output. The estimates 40a, 40b can take various forms, as described above. Binary information about whether or not the input data and the output data are similar to the data sets used for training, for example, can be output. Alternatively (or additionally) a metric or other characteristic variable for the similarity can be output.

In some examples, the closed-loop test platform 81 for testing a system is a closed-loop simulation platform; i.e. the surroundings of the system under test, the system under test, or both are generated by means of a simulation. Input data supplied to the system under test in the closed-loop test platform can be generated by means of a simulation, for instance (e.g. by simulating other systems that provide input data to the system under test, a surroundings of the system under test, or both). Additionally or alternatively, the output data of the system under test can be at least partially fed back into the simulation.

In some examples, the method comprises outputting a plurality of estimates of the similarity of input data and output data of a data set 61, 61b of the closed-loop test platform for testing a system 81 (i.e. the closed-loop test platform to be validated or verified) and the data sets of the at least one reference test platform with the machine learning module 83. The plurality of estimates can be estimates of similarity for different values of operating parameters of the system under test and/or different operating scenarios or operating situations. This information makes it possible to identify whether a closed-loop test platform 81 to be validated or verified is adequately testing specific regions (or not).

The estimates of the similarities 40a, 40b can be output in any suitable manner. In some examples, the one or more estimates of the similarities 40a, 40b are output in a graphical user interface. In other examples, the estimates can also be output via other interfaces (in human- or machine-readable form).

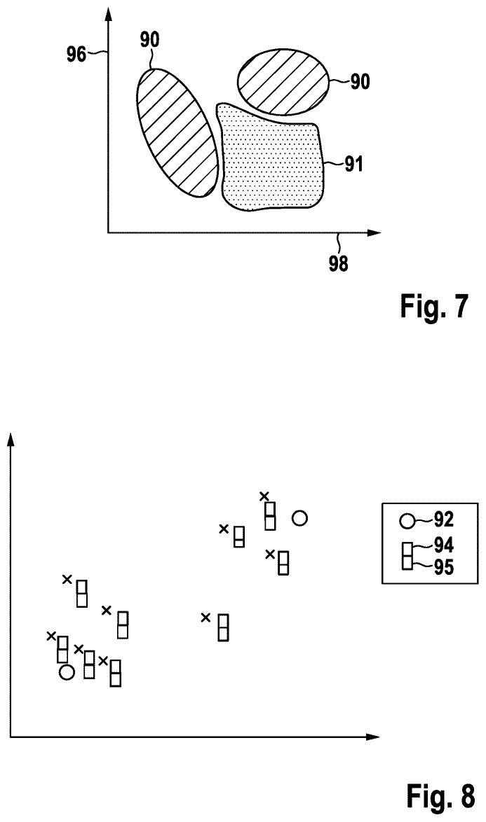

Further aspects of the estimates of similarities that can be output will now be discussed with reference to FIG. 7 or FIG. 8. FIG. 7 shows an example output of a method for validating or verifying a closed-loop test platform of this disclosure. FIG. 8 shows another example output of a method for validating or verifying a closed-loop test platform of this disclosure.

In some examples, the estimates can be ascertained and output for different points or regions of a parameter space. FIG. 7 and FIG. 8 show examples of a two-dimensional parameter space (with a first axis 96 that plots a first parameter and a second axis 97 that plots a second parameter). In other examples, the parameter space can have more than two dimensions. In yet other examples, estimates can be output for two or more operating scenarios and/or operating situations of the system.

The estimates of the similarities can now be used to identify regions 90 in the parameter space, in which the closed-loop test platform to be validated or verified provides adequate results (e.g. input data and output data are similar to the input data and output data of the reference test platforms under a predetermined similarity criterion), and other regions 91, in which the closed-loop test platform to be validated or verified does not provide adequate results (e.g. input data and output data are not similar to the input data and output data of the reference test platforms under a predetermined similarity criterion). The assessment can be carried out automatically and output to a user (e.g. via a graphical user interface). In other examples, instead of a binary classification (“similar” or “dissimilar”), a probabilistic classification can be carried out and/or a value for a similarity metric can be output.

FIG. 8 shows an output (e.g. via a graphical user interface) in which estimates of the similarities are output for a plurality of points of a parameter space. For each point, a (first) estimate 94 of the similarity of the input data and a (second) estimate 95 of the similarity of the output data can be output. Data points 92 or parameter ranges for which data sets for reference test platforms are available can be identified as well.

Based on the output of the similarities, one or more further steps can be taken (which can be carried out automatically in some examples).

In some examples, it is in particular possible to check data sets (e.g. for specific test runs of a closed-loop test platform to be validated or verified) for which no data of a reference test platform (e.g. the system under test in the field) is available for reliability. In some cases, the trained machine learning module can make a reliable estimate as to whether the data of the closed-loop test platform to be validated or verified has sufficient similarity to the expected data for these data sets as well.

In some examples, the one or more estimates 40a, 40b can additionally or alternatively be used to determine a coverage of a parameter space by the closed-loop test platform to be validated or verified and/or the at least one reference test platform. For instance, regions for which no data from reference test platform are available yet can be identified. Additional data can be requested and/or collected for these regions. For instance, data that addresses specific operating situations or operating scenarios can be requested and/or collected for the closed-loop test platform to be validated or verified and/or the at least one reference test platform (e.g. if there are no portions of the closed-loop test platform to be validated or verified that are similar to portions in the data sets of the reference test platform, or vice versa).

Additionally or alternatively, targeted new data sets can be requested (and generated) for the closed-loop test platform to be validated or verified to increase similarity to the data sets of the reference test platform (e.g. by fuzzing the input data).

Once a closed-loop test platform has been validated or verified using the techniques of this disclosure, the system under test included therein can be released and used further (e.g. in a product or in a downstream stage of a development process). The present disclosure also includes using the system included in the closed-loop test platform.

In the preceding sections, the techniques of this disclosure have mostly been explained using the methods of this disclosure. In some examples, the methods of this disclosure can be carried out automatically (e.g. computer-implemented).

The present disclosure also relates to a computing unit which is configured to carry out the methods according to this disclosure. The computing unit can take any suitable form in terms of its hardware or software (e.g. a stand-alone computing unit or a distributed computing unit, e.g. a computing unit in a cloud).

The present disclosure also relates to a computer program that contains instructions that, when executed on a computing unit, cause the computing unit to carry out the steps of the methods of this disclosure.

The present disclosure also relates to a computer program product or signal containing the computer programs of this disclosure.

1-17. (canceled)

18. A method for training a machine learning module to validate or verify a closed-loop test platform for validating or verifying a system, comprising the following steps:
providing a plurality of data sets from two or more closed-loop test platforms of which at least one is a reference test platform, wherein each data set contains input data and associated output data of a system under test in a respective closed-loop test platform of the closed-loop test platforms;
determining similarities of portions of the input data for pairs of the plurality of data sets, wherein each pair of data sets of the pairs contains a data set of one of the at least one reference test platforms;
determining similarities of portions of the output data associated with the portions of input data; and
training a machine learning module to estimate a similarity of input data and output data of a data set of the closed-loop test platform to be validated or verified and the data sets of the plurality of data sets of the at least one reference test platform as a function of input data and/or output data of the data set of the closed-loop test platform to be validated or verified using the determined similarities to create the machine learning module for validating or verifying the closed-loop test platform.

19. The method according to claim 18, wherein the machine learning module receives only a part of the input data and/or output data of the data set of the closed-loop test platform to be validated or verified as an input variable and generates the estimate of the similarity of the input data and output data as an output variable.

20. The method according to claim 19, wherein the part of the input data and/or output data contains information that characterizes an operating scenario acquired or simulated with the respective closed-loop test platform or an operating situation acquired or simulated with the respective closed-loop test platform of a system included in the closed-loop test platform.

21. The method according to claim 18, wherein the portions of output data and/or the portions of the input data include sections of time records.

22. The method according to claim 18, wherein the portions of output data and/or the portions of the input data are selected to contain data relating to one or more predetermined operating situations or one or more predetermined operating scenarios of the system under test in the respective closed-loop test platform.

23. The method according to claim 22, wherein the predetermined operating situations or operating scenarios are critical operating situations or operating scenarios of the system, wherein the critical operating situations or operating scenarios include the violation of a predetermined safety objective.

24. The method according to claim 18, wherein determining the similarities of portions of input data includes determining a distance between a first portion of input data of a first data set of a respective pair and a second portion of input data of a second data set of the respective pair.

25. The method according to claim 18, wherein the determining of the similarities of portions of input data includes compressing individual portions and comparing the compressed portions of input data.

26. The method according to claim 25, wherein the compressing of the individual portions includes generating a datum characteristic of each respective portion with lower dimensionality than an original portion.

27. The method according to claim 18, wherein the system includes a vehicle or a module for use in a vehicle.

28. The method according to claim 18, wherein the at least one reference test platform includes at least one test platform including the system in the field or on a test stand.

29. A method for validating or verifying a closed-loop test platform for testing a system, comprising the following steps:
providing a data set of a closed-loop test platform for testing a system;
feeding at least a portion of the data set of the closed-loop test platform into a machine learning module for validating or verifying a closed-loop test platform, wherein the machine learning module is trained to estimate similarity of input data and output data of a data set of a closed-loop test platform to be validated or verified and data sets of at least one reference test platform as a function of input data and/or output data of the data set of the closed-loop test platform to be validated or verified; and
outputting one or more estimates of the similarity of input data and output data of the data set of the closed-loop test platform for testing a system and the data sets of the at least one reference test platform with the machine learning module.

30. The method according to claim 29, wherein the closed-loop test platform for testing a system is a closed-loop test platform that simulates the system under test and/or surroundings of the system under test.

31. The method according to claim 29, further comprising:
outputting a plurality of estimates of the similarity of input data and output data of the data set of the closed-loop test platform for testing a system and the data sets of the at least one reference test platform with the machine learning module, wherein the plurality of estimates are estimates of similarity for different values of operating parameters of the system under test and/or different operating scenarios.

32. A computing unit configured to train a machine learning module to validate or verify a closed-loop test platform for validating or verifying a system, the computing unit configured to:
provide a plurality of data sets from two or more closed-loop test platforms of which at least one is a reference test platform, wherein each data set contains input data and associated output data of a system under test in a respective closed-loop test platform of the closed-loop test platforms;
determine similarities of portions of the input data for pairs of the plurality of data sets, wherein each pair of data sets of the pairs contains a data set of one of the at least one reference test platforms;
determine similarities of portions of the output data associated with the portions of input data; and
train a machine learning module to estimate a similarity of input data and output data of a data set of the closed-loop test platform to be validated or verified and the data sets of the plurality of data sets of the at least one reference test platform as a function of input data and/or output data of the data set of the closed-loop test platform to be validated or verified using the determined similarities to create the machine learning module for validating or verifying the closed-loop test platform.

33. A non-transitory computer-readable medium on which is stored a computer program training a machine learning module to validate or verify a closed-loop test platform for validating or verifying a system, the computer program, when executed by a computer, causing the computer to perform the following steps:
providing a plurality of data sets from two or more closed-loop test platforms of which at least one is a reference test platform, wherein each data set contains input data and associated output data of a system under test in a respective closed-loop test platform of the closed-loop test platforms;
determining similarities of portions of the input data for pairs of the plurality of data sets, wherein each pair of data sets of the pairs contains a data set of one of the at least one reference test platforms;
determining similarities of portions of the output data associated with the portions of input data; and
training a machine learning module to estimate a similarity of input data and output data of a data set of the closed-loop test platform to be validated or verified and the data sets of the plurality of data sets of the at least one reference test platform as a function of input data and/or output data of the data set of the closed-loop test platform to be validated or verified using the determined similarities to create the machine learning module for validating or verifying the closed-loop test platform.
